(19) United States
(12) Patent Application Publication
(10) Pub. No.: US 2004/0118002 A1
(43) Pub. Date: Jun. 24, 2004

(54) Tape measure

(76) Inventor: Jin-Chu Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/322,542

(22) Filed: Dec. 19, 2002

(51) Int. Cl. G01B 3/10

(52) U.S. Cl. 33/767

(57) ABSTRACT

A tape measure comprising a calibrated tape, a reel shaft around which the tape is reeled up into a spool, and a housing in which the reel shaft is rotatably mounted and the spool is received. In order to avoid the disadvantages resulting from a too fast reel-up speed, there is provided a unilateral deceleration brake, which effects only in the reel-up direction of the tape, with a plurality of brake shoes and corresponding presressed spring means and a rotor carrying the brake shoes, wherein the rotor is coaxially and unrotatably mounted on an extension part of the reel shaft, and the brake shoes are pivotally jointed to the rotor and biased by the spring means to remain in a first position, in which the brake shoes are spaced from the inner wall of the housing by a predetermined clearance. The brake shoes and the spring means are such that each of the brake shoes is pushed radially outwardly to a second position where a brake shoe contacts with the inner wall of the housing, when the tape is reeled up at a speed above a threshold, at which the corresponding centrifugal force of the brake shoe exceeds the prestressed tension of the spring means.

### BACKGROUND OF THE INVENTION

This invention relates to a tape measure, in particular to a tape measure with a coaxial brake to retard the speed when its calibrated tape is reeled up, thereby preventing the risk of the injury of a user by the too fast accelerated thin edges of the calibrated tape or the damage of the housing causes by the violent impact of the puller or the sideway deviation of the tape due to a too fast reel-up speed.

Tape measure of different length and types are widely used in many fields. In order to compact the calibrated or graduated tape, which generally measures 3 to 5 m in length, it is reeled up into a spool around a reel shaft in a D-shaped case or housing in which the reel shaft is rotatably mounted, as typically illustrated in FIG. 5. To avoid the complete retraction of the free end of the calibrated tape into the housing and to facilitate the seizure thereon, the tip of the calirated tape is provided with an L-shaped puller, which remains outside of the outlet of the housing when the tape is completely reeled up. Normally a coaxial resumption-torsion-spring is provided so that the calibrated tape, which was pulled out, can be automatically and resiliently reeled up if the puller is released. In order to retain the calibrated tape at a pulled-out length and position without holding the puller, there is provided a locking brake, which is actuated by a shifter slidably mounted on the housing. If one release the locking brake by shifting the shifter, the calibrated tape will be automatically reeled up by the resumptive force of the torsion-spring.

The disadvantages of the conventional tape measure consists in that it suffers the following risks, if the resumptive force is too powerful and therfore the calibrated tape is reeled up too fast:

1) The reel-up speed increases with the increasing reeled-up length of the tape and reaches its maximun toward the end of the reel-up motion. As a result the puller violently hits the housing, which is mostly made of plastic materials and therefore somewhat vulnerable to such a strong impact that may lead to the damage or deformation of the housing. At the same time a unpleasant noise is generated by the impact of the puller onto the housing. Also the puller may be detached from the tape due to the shock and lost.

2) The thin edges of the calibrated tape, often made of highly elastic alloy material, when moving at a high speed, are as dangerous as a sharp blade, thus seriously endangering the user.

3) Moreover, a too high reel-up speed may result in the transverse fluctuation of the movement (i.e. very slight “undulation”) and therefore the sidway deviation of the location of the tape, and the deviation may summatorily accumulated with the repeated pull-out/reel-up cycles and grows greater and greater. Consequently the spool is becoming less and less compact, and the tape is becoming harder and harder to pull out/reel up.

Accordingly, it is the chief object to provide a tape measure, by which the aforementioned disadvantages, all resulting from a too fast reel-up, which is responsible for the injury of the user and the damage of the housing as well as the sideway deviation of the tape, are obviated.

According to this invention, this object is achieved by a unilateral deceleration brake (not to be confused with the conventional locking brake !) which is coaxially mounted on the reel shaft and which only works to retard the tape when the reel-up speed exceeds a predetermined threshold, therefore preventing the disadvantages connected with the too high reel-up speed.

In order to selectively actuate the braking effect only in the reel-up direction and above a critical speed, there are provided a plurality of arcuated brake shoes, of which the front end (seen in the reel-up direction) is pivotably jointed to a rotor coaxially and unrotatably fixed on the reel shaft, and which, in their unactuated position, are spaced apart from the inner wall of the housing by a narrow clearance. Each brake shoe is biased radially inwardly by a prestressed tension spring to cling tightly on the rotor. The brake is only actuated when the tape is accelerated to such a high speed, at which the corresponding centrifugal force of the brake shoes is enough to overcome the prestressed tension of the tension spring. Then the brake shoes are shaked radially outwardly to reach and contact with the inner wall of the housing, thus accomplishing a braking effect. The faster the reel-up speed, the stronger the centrifugal force of the brake shoes, and therefore the stronger the braking effect will be. When the tape is pulled out or when the reel-up speed is safely under the critical threshold, the brake shoes remain clinging on the rotor and there is no friction between the brake shoes and the housing. Thus the smooth pull-out/reel-up is not aggravated by a useless friction.

In order to receive the coaxial deceleration brake, the housing has a lengthend shaft, forming an extension part, and an enlarged axial dimension, defining an extra interior space for the deceleration brake.

According to a further feature of this invention, the inner wall of the housing, which serves as brake drum, is made of, or provided with a lining of a material highly resistant to wear, in order to prolong the life of the tape measure.

This invention will become apparent when read in connection with the accompanying drawings, in which:

### BRIEF DESCRIPTION OF THE DRAWING

The present invention will be better understood by reference to the accompanying drawings, wherein:

FIG. 1 is a perspective fragmentary view of a tape measure according to this invention;

FIGS. 2 and 3 are the sectional view, along a normal plane, of the tape measure in FIG. 1, respectively with the brake shoes spaced apart from and in contact with the inner wall of the housing;

FIG. 4 is another sectional view, along another plane in which the tape is pulled out; and

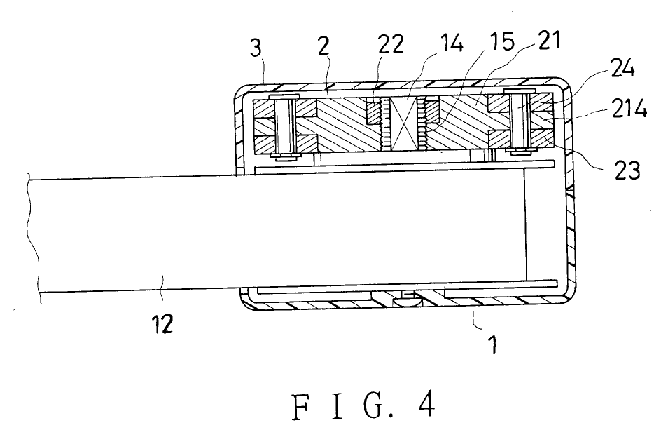

FIG. 5 is a conventional tape measure.

### DETAILED DESCRIPTION OF PREFERRED EMBODIMENT

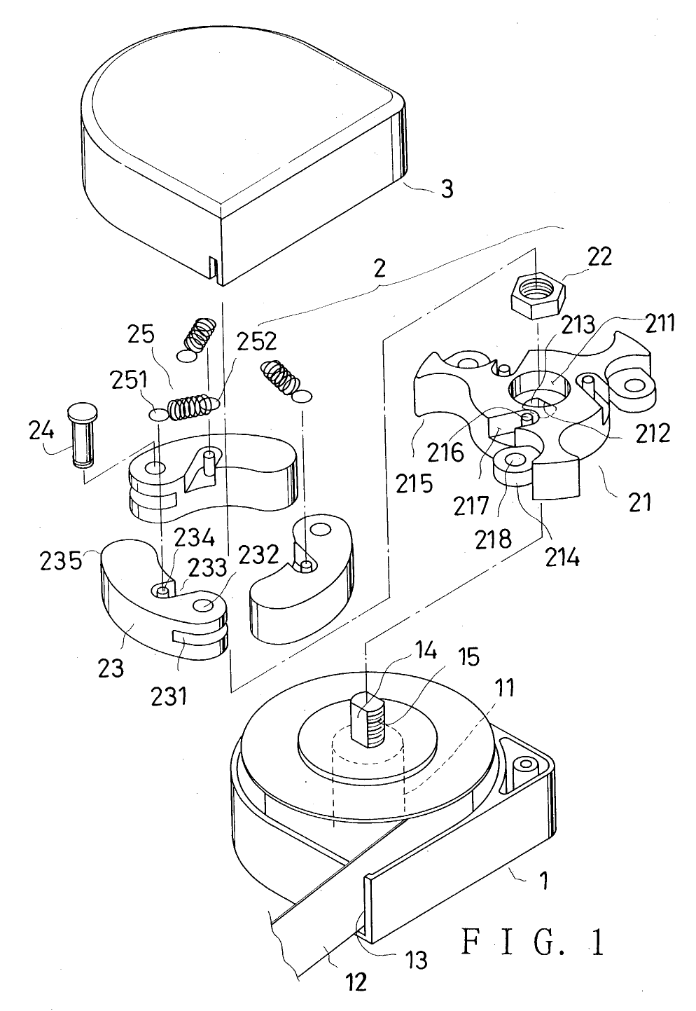

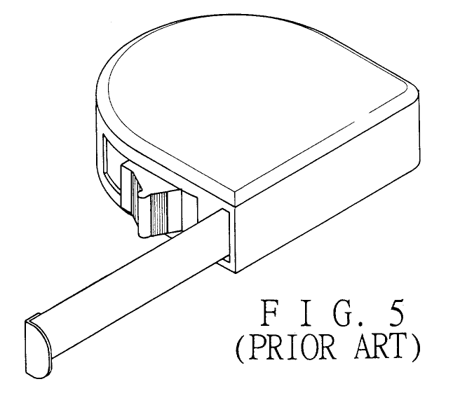

As shown in FIG. 1, a tape measure according to this invention comprises the same conventional parts as the known tape measure in FIG. 5, such as a calibrated tape 12 reeled up into a spool around a reel shaft 11, and a housing with an outlet. The housing is composed of two halves, namely a main part 1 and a cover part 3. Unlike the conventional tape measure, this invention further comprises a coaxial unilateral deceleration brake 2 with a plurality of (here three) arcuated brake shoes 23 carried by a rotor 21 coaxially and unrotatably mounted on an extension part 15 of the reel shaft 11. In order to fix the rotor 21 unrotably on the reel shaft 11, the extension has a non-circular transverse section which is a truncated circle with two leveled sides 14. Correspondingly, the rotor 21 has a central hole 213, likewise with the shape of a truncated circle with two leveled sides, to form a complementary positive coupling with the extension 15. Around the hole 213 there is a recess 211 for a nut 22, which is screwed on the extension 15 to secure the rotor in place on the reel shaft 11. For this purpose, the extension part 15 is provided with two diametrically opposite partial threads (only one is shown in FIG. 1).

Preferably, the arrangement of the brake shoes is symmetrical to the axis of the reel shaft 11 to ensure the unchangeability of the mass center during the reel-up or pull-out. Otherwise a fluctuation of mass center, and therefore an unstability of the rotor 21 will occur due to the asymmetry of the brake shoes.

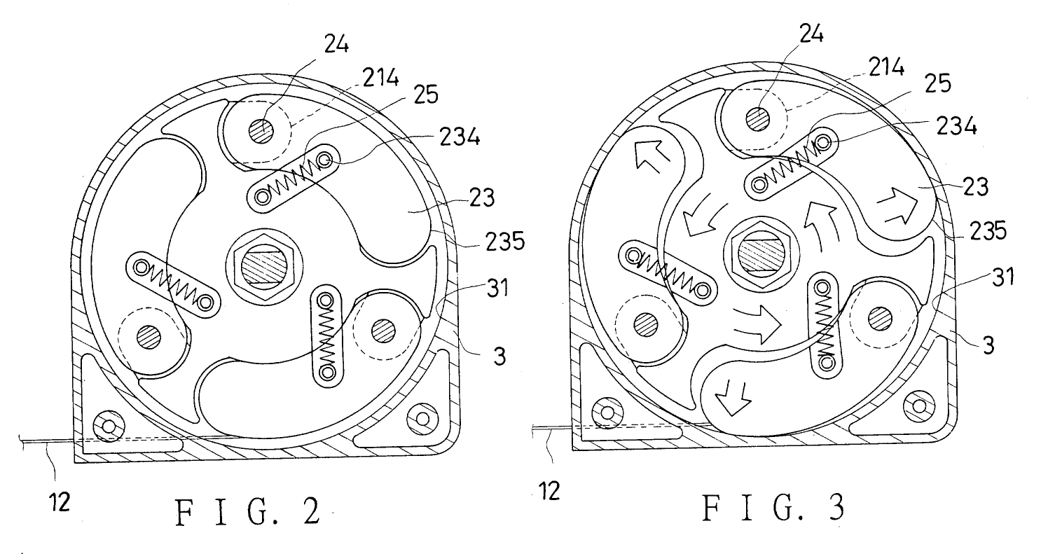

The rotor 21 is provided with three recesses 215 complementarily receiving the three brake shoes 23 around its periphery. The front end (seent in the reel-up direction, as illustrated by the circumferential arrows in FIG. 3) of each brake shoe 23 is pivotally jointed by means of a pivot pin 24 with its radially inner side lying on the rotor 21 under the tension of the prestressed tension spring 25 (FIG. 2). If the reel-up speed exceeds a predetermined threshold, then the brake shoe 23 is shaked radially outwardly by the excessive centrifugal force (as illustrated in FIG. 3 by the radially oriented arrows) and the outward radial displacement increases with the rising reel-up speed until the rear end 235 of the brake shoe 23 touches the inner wall of the housing 3 (see FIG. 3), thus starting a braking effect.

In order to pivotally joint the brake shoe 23 to the rotor 21, the latter is provided with three male hinges 214, which complementarily cooperate with the three female hinges 231. Each male hinge 214 has an eyelet 218, which is aligned with the corresponding eyelets 232 of each female hinge 231 when the two opposite hinges 214,231 engage with each other. A pivotal pin 24 extends through each hinge couple 214,231 to pivotally joint a brake shoe 23 to the rotor 21.

In order to retain the tension springs 25 in a protected manner, the rotor 21 is provided with three grooves 217 in form of a splitted blind hole, each of which is open at its outer end and extends substantially in the tangentiaL direction of the recess 211, to receive the proximal half of each tension spring 25. Correspondingly, each brake shoe 23 has an open-end groove 233 in form of a splitted blind hole for the distal half of each tension spring 25. Thus the spring 25 is safely protected in a “trench”formed by the grooves 217,233 from the harmful contact of foreign parts. Both ends of each tension spring are provided with a loop 251,252. The two loops 252,252 are respectively anchored to a pin 234 or 216 formed at the blind end of each groove 233 or 217.

Referring to FIG. 3, if the reel-up speed exceeds the critical value, the rear end 235 of each brake shoe 23 will be centrifugally pushed outwardly to contact with the inner wall of the housing 3. The faster the tape 12 is reeled up, the stronger the centrifugal force, and therefore the friction will be. Thus the reel-up speed is immediately reduced to a safe degree. In order to increase the friction between the brake shoes 23 and the inner wall of the housing 3, the rear end 235 is roughened. Correspondingly the inner wall of the housing part 3 is fabricated by or lined with a material which is highly resistant to wear, so as to prolong the life of the tape measure.

When the tape 12 is pulled outwardly each of the brake shoes 23 is subject to the prestressed tension of the spring 25 and its own centripetal force, both pulling it radially inwardly. When the tape 12 is reeled up with a speed in the safe range, it is the prestressed tension that dominates the brake shoes. Thus the brake shoes remain lying on the rotor 21. In both cases the tape measure works frictionlessly.

In comparison with the conventional tape measure, this invention has the following advantages over the former:

1) With the safety brake, which is automatically triggered when the reel-up speed is dangerously high, a violent hit of the puller on the housing that would otherwise lead to the damage of the latter and the detachment of the puller itself, is avoided.

2) The braking effect increases with the increasing reel-up speed. Thus the free end with the puller is suject to a retardation instead of an excessive acceleration when approaching the tape outlet on the housing.

3) Thanks to the braking effect, the risk of injury by the thin edges of the too fast accelerated tape is avoided.

4) With the braking effect, the sideway deviation of the tape resulting from a too fast reel-up can be avoided.

What is claimed is:

1. A tape measure comprising a calibrated tape, a reel shaft around which said tape is reeled up into a spool, and a housing in which said reel shaft is rotatably mounted and said spool is received, the improvements comprising a unilateral deceleration brake effecting only in the reel-up direction of said tape, with a plurality of brake shoes and corresponding presressed spring means and a rotor carrying said brake shoes, said rotor being coaxially and unrotatably mounted on an extension part of said reel shaft, said brake shoes being pivotally jointed to said rotor and biased by said spring means to remain in a first position, in which said brake shoes are spaced from the inner wall of said housing by a predetermined clearance, said brake shoes and said spring means being such that each of said brake shoes is pushed radially outwardly to a second position where said brake shoe contacts with the inner wall of said housing, when said tape is reeled up at a speed above a threshold, at which the corresponding centrifugal force of said brake shoe exceeds the prestressed tension of said spring means.

2. A tape measure according to claim 1, wherein said housing is formed by a first part in which said spool is received, and a second part, in which said deceleration brake is received.

3. A tape measure according to claim 2, wherein the inner wall of said second part of said housing is highly resistant to wear.

4. A tape measure according to claim 1 or 2, wherein said extension part has a non-circular transverse section, and said rotor has a central hole complmentary to said extension part.

5. A tape measure according to claim 1 or 2, wherein said hole has the form of a truncated circle with two leveled sides, and said extension part, likewise with a transverse section in the form of a trucated circle, has partial thread on the area outside said leveled sides.

6. A tape measure according to claim 1 or 2, wherein said rotor and said brake shoes are provided with cooperating grooves in which said spring means are received.

7. A tape measure accoding to claim 1 or 2, wherein each of said grooves is provided with a pin, and each of said springs has two loops at both ends to be anchord to said pins.

8. A tape measure according to claim 1 or 2, wherein said brake shoes are arranged symmetrically to the axis of said reel shaft.
